(19) United States
(12) Patent Application Publication
(10) Pub. No.: US 2026/0316503 A1
(43) Pub. Date: Oct. 15, 2026

(54) ROLL CENTER HEIGHT POSITION ADJUSTMENT MECHANISM

(71) Applicant: SUBARU CORPORATION, Tokyo (JP)

(72) Inventors: Koichi UCHIKAWA, Tokyo (JP); Satoru AKIYAMA, Tokyo (JP); Qiaoqin ZHOU, Tokyo (JP)

(73) Assignee: SUBARU CORPORATION, Tokyo (JP)

(21) Appl. No.: 19/326,231

(22) Filed: Sep. 11, 2025

(30) Foreign Application Priority Data
Sep. 18, 2024 (JP) 2024-161364

(51) Int. Cl. B60G 3/26; B60G 3/20; B60G 7/00; B60G 7/02

(52) U.S. Cl. CPC B60G 3/26; B60G 3/202; B60G 7/008; B60G 7/02

(57) ABSTRACT

A roll center height position adjustment mechanism for adjusting a roll center height position in a suspension apparatus for a vehicle includes a lower arm, an upper arm, and an intermediate mounting member. The lower arm swingably supports a wheel in an up-down direction with respect to a vehicle body and has an upward inclination.

The upper arm swingably supports the wheel in the up-down direction with respect to the vehicle body and has a downward inclination. The intermediate mounting member is positioned between the upper arm and the vehicle body and fixes them together. The intermediate mounting member has a vehicle body mounting portion at which the upper arm is fixed to the vehicle body. The vehicle body mounting portion has a roll center height position to be set variably in accordance with vehicle specifications.

### CROSS-REFERENCE TO RELATED APPLICATIONS

The present application claims priority from Japanese Patent Application No. 2024-161364 filed on Sep. 18, 2024, the entire contents of which are hereby incorporated by reference.

### BACKGROUND OF THE INVENTION

### Field of the Invention

The disclosure relates to an adjustment mechanism for adjusting a roll center height position in a suspension apparatus for a vehicle such as an automobile.

### Description of Background Art

Japanese Unexamined Patent Application Publication (JP-A) No. 2019-1328 describes a suspension apparatus including a roll center variable mechanism. The entire contents of this publication are incorporated herein by reference.

### SUMMARY OF THE INVENTION

According to one aspect of the disclosure, a roll center height position adjustment mechanism for adjusting a roll center height position in a suspension apparatus for a vehicle includes a lower arm, an upper arm, and an intermediate mounting member. The lower arm swingably supports a wheel in an up-down direction with respect to a vehicle body of a vehicle and is positioned such that the lower arm has an upward inclination from a position lower than a rotation center of the wheel toward the vehicle body. The upper arm swingably supports the wheel in the up-down direction with respect to the vehicle body and is positioned such that the upper arm has a downward inclination from a position higher than the rotation center of the wheel toward the vehicle body. The intermediate mounting member is positioned between the upper arm and the vehicle body and fixes the upper arm to the vehicle body. A vehicle body mounting portion is positioned in the intermediate mounting member such that the vehicle body mounting portion is a point at which the upper arm is fixed to the vehicle body and has a roll center height position that is set variably in accordance with vehicle specifications.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view illustrating a schematic configuration of a suspension apparatus including a roll center height position adjustment mechanism according to one embodiment of the disclosure;

FIG. 2 is a view illustrating a second adjustment adapter applied to the roll center height position adjustment mechanism of FIG. 1;

FIG. 3 is a view illustrating a modification example of the roll center height position adjustment mechanism according to one embodiment of the disclosure; and

FIG. 4 is a schematic diagram for describing a roll center.

### DETAILED DESCRIPTION OF THE EMBODIMENTS

Embodiments will now be described with reference to the accompanying drawings, wherein like reference numerals designate corresponding or identical elements throughout the various drawings.

The drawings used for the following description are schematically illustrated. Thus, in each of the drawings, each constituent element is illustrated with a recognizable size in the drawing. For this reason, dimensional relationships, scales, and the like of respective members in the drawings are sometimes illustrated differently for each constituent element. The disclosure is not limited to illustrated forms alone in terms of the number of each of the constituent elements, the shape of each of the constituent elements, the size ratio of the respective constituent elements, the relative positional relationship among the respective constituent elements, and the like depicted in the respective drawings.

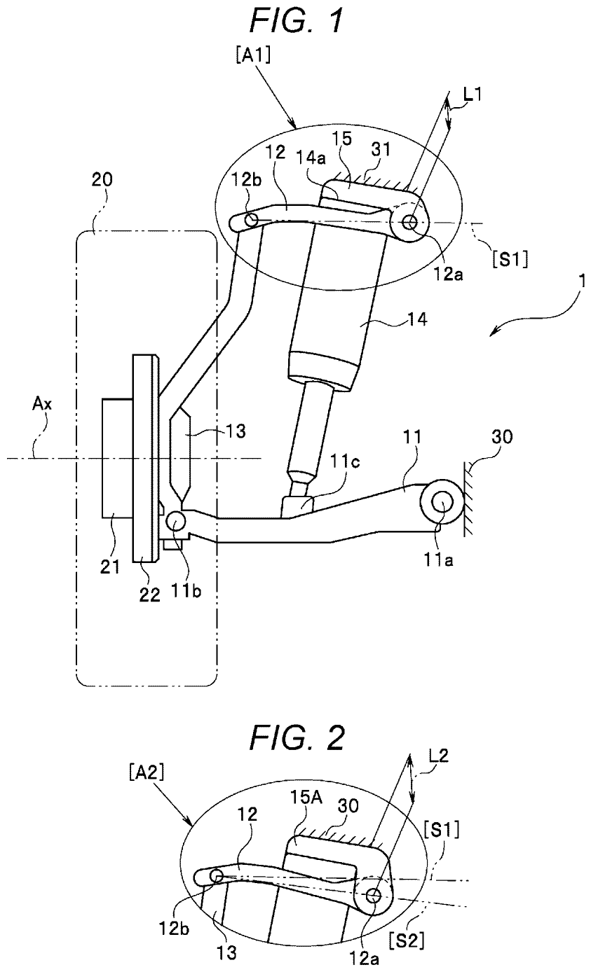

A description will be given below of a schematic configuration of a suspension apparatus including a roll center height position adjustment mechanism according to one embodiment of the disclosure. FIG. 1 is a view illustrating a schematic configuration of a suspension apparatus including a roll center height position adjustment mechanism according to one embodiment of the disclosure. FIG. 2 is a view illustrating a second adjustment adapter applied to the roll center height position adjustment mechanism of FIG. 1. The range indicated by reference sign [A2] in FIG. 2 indicates substantially the same range as the range indicated by reference sign [A1] in FIG. 1.

As illustrated in FIG. 1, a suspension apparatus 1 including the roll center height position adjustment mechanism according to the present embodiment shows an exemplary configuration as a double wishbone suspension apparatus of a high mount upper arm type.

The configuration of the suspension apparatus 1 is basically substantially similar to the configuration of a double wishbone suspension apparatus of a high mount upper arm type which has been typically put into practical use and widely used in the related art. The configuration of the present embodiment is different from the conventional configuration in that the suspension apparatus 1 includes the roll center height position adjustment mechanism. Thus, configurations other than the roll center height position adjustment mechanism will be briefly described.

The suspension apparatus 1 includes a lower arm 11, an upper arm 12, a knuckle 13, a shock absorber 14, an adjustment adapter (see reference sign 15 in FIG. 1 and reference sign 15A in FIG. 2), and the like.

The lower arm 11 is a cantilevered arm member having one ends swingably supported by left and right fixing parts (not illustrated; see reference sign 30 in FIG. 1) of a side frame or the like of a vehicle (not illustrated) and disposed to project outward in a vehicle lateral direction.

The lower arm 11 swingably supports the wheel 20 (see FIG. 1) in an up-down direction with respect to a vehicle body (not illustrated). The lower arm 11 has an upward inclination from a position lower than a rotation center axis Ax (see FIG. 1) of the wheel 20 toward the vehicle body (not illustrated).

The lower arm 11 has a form in which, for example, two shaft members are disposed as two sides of a triangular or U-shape. Here, the respective other ends of the two shaft members intersect at vertices of the two sides of the triangular or U-shape to form an action point 11b. The action point 11b is coupled to a part (first coupler) on a lower part side of the knuckle 13 to be described later. Respective one ends of the two shaft members (respective one ends of the two sides of the triangular or U-shape) form swing points 11a swingably supported by the left and right fixing parts as described above. With this configuration, the lower arm 11 is formed in a cantilever shape swinging at the two swing points 11a, and swingably supports the knuckle 13 coupled to the action point 11b.

The upper arm 12 is a cantilevered arm member having one ends swingably supported by a fixing member (e. g., a part of an upper strut mount 14a or the like) fixed to a fixing part (not illustrated; see reference sign 31 in FIG. 1) of the vehicle (not illustrated) and disposed to project outward in the vehicle lateral direction.

The upper arm 12 swingably supports the wheel 20 (see FIG. 1) in the up-down direction with respect to the vehicle body (not illustrated). The upper arm 12 has a downward inclination from a position higher than the rotation center axis Ax (see FIG. 1) of the wheel 20 toward the vehicle body (not illustrated).

The upper arm 12 has a form in which, for example, two shaft members are disposed as two sides of a triangular or U-shape. Here, the respective other ends of the two shaft members intersect at vertices of the two sides of the triangular or U-shape to form an action point 12b. The action point 12b is coupled to a part (second coupler) on an upper part side of the knuckle 13 to be described later. Respective one ends of the two shaft members (respective one ends of the two sides of the triangular or U-shape) form swing points 12a swingably supported by the fixing part (e.g., the part of the upper strut mount 14a or the like) as described above. With this configuration, the upper arm 12 is formed in a cantilever shape swinging at the two swing points 12a, and swingably supports a part of the knuckle 13 coupled to the action point 12b.

The knuckle 13 is a member that rotatably supports, around the rotation center axis Ax, a disc brake apparatus 22 and a wheel hub 21 to which the wheel 20 is mounted. The knuckle 13 includes a first coupled part to which the first coupler of the lower arm 11 is coupled and a second coupled part to which the second coupler of the upper arm 12 is coupled.

The shock absorber 14 is a buffer that reduces an expansion and contraction force of a coil spring (not illustrated) included in the suspension apparatus 1. The shock absorber 14 has an upper end supported by the upper strut mount 14a and a lower end supported by a part 11c of the lower arm 11.

The adjustment adapter 15 is an intermediate mounting member that is provided between the upper arm 12 and the vehicle body (not illustrated) and fixes the upper arm 12 to the vehicle body. The adjustment adapter 15 (intermediate mounting member) has vehicle body mounting portions (pivots) at which the upper arm 12 is fixed to the vehicle body. In this case, the vehicle body mounting portions (pivots) are set at positions corresponding to the swing points 12a of the upper arm 12.

The adjustment adapter 15 has, for example, a substantially L-shaped cross section, a long side part disposed so as to cover the upper strut mount 14a, and a short side part formed so as to extend downward from a plane of the upper strut mount 14a. The short side part has a pivot (not illustrated) that swingably supports the swing point 12a.

For the roll center height position adjustment mechanism according to the present embodiment, as the adjustment adapter 15 having the above-described form, a second adjustment adapter 15A having a different form is prepared. As an exemplary configuration of the second adjustment adapter 15A, for example, a form is illustrated in FIG. 2 in which the length dimension of the short side part and the pivot position of the short side part are different.

Here, as illustrated in FIG. 1, the adjustment adapter 15 having a form in which the pivot position is set to a dimension L1 is referred to as a first adjustment adapter. On the other hand, as illustrated in FIG. 2, the second adjustment adapter 15A has a form in which the pivot position is set to a dimension L2. Here, the dimensions L1 and L2 are set such that L2 is greater than L1 (L2>L1).

In this case, the straight line coupling the action point 12b and the swing point 12a of the upper arm 12 in a case where the first adjustment adapter 15 illustrated in FIG. 1 is applied and the straight line coupling the action point 12b and the swing point 12a of the upper arm 12 in a case where the second adjustment adapter 15A illustrated in FIG. 2 is applied have different inclination angles with respect to the horizontal line as indicated by reference sign [S1] in FIG. 1 and reference sign [S2] in FIG. 2.

That is, the position of the swing point 12a of the upper arm 12 can be variable up and down between the case where the first adjustment adapter 15 of FIG. 1 is applied and the case where the second adjustment adapter 15A of FIG. 2 is applied. Accordingly, the adjustment adapters 15 and 15A serve as an adjustment mechanism for adjusting the roll center height position.

As described above, in the suspension apparatus 1 including the roll center height position adjustment mechanism according to the present embodiment, different types of adjustment adapters (15, 15A) having different pivot positions are prepared in advance, and the positions of the swing points 12a of the upper arm 12 can be set simply by appropriately and selectively using one of the different adjustment adapters (15, 15A). As a result, the roll center height position can be appropriately adjusted to a desired position.

Thus, even when a common platform is used and the same suspension apparatus is applied to vehicles having different vehicle specifications (e.g., one or more of a vehicle height (suspension orientation or wheel outer diameter), a tread, which is a center-to-center distance of left and right wheels in a vehicle width direction, and the like), the roll center height position can be set to be substantially the same position by appropriately and selectively applying one of the different adjustment adapters (15, 15A).

Thus, even in different vehicle types, the maneuverability, the ride comfort performance, and the like can be maintained at substantially the same level.

The one embodiment exemplifies the configuration in which different types of adjustment adapters (15, 15A) having different pivot positions are prepared. The disclosure is not limited to the exemplary configuration according to the one embodiment. In addition to the above exemplary configuration, for example, a modification example as described below is also conceivable.

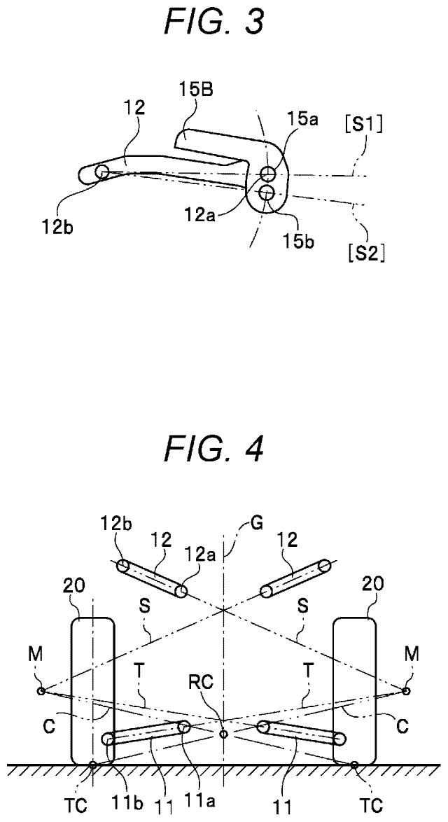

FIG. 3 is a view illustrating a modification example of the roll center height position adjustment mechanism according to one embodiment of the disclosure.

In an adjustment adapter 15B exemplified using this modification example, the swing point 12a of the upper arm 12 can be selectively set to any of positions by using a single member.

As illustrated in FIG. 3, the adjustment adapter 15B of the present modification example has a short side part having (in the present example, two) pivots (15a, 15b) whose positions are different in the up-down direction (direction along the short side).

Here, a first pivot 15a is located on the straight line [S1] coupling the swing point 12a and the action point 12b of the upper arm 12, and supports the swing point 12a. A second pivot 15b is located on the straight line [S2] coupling the swing point 12a and the action point 12b of the upper arm 12, and supports the swing point 12a.

As described above, in the adjustment adapter 15B, a setting is made such that either of the first pivot 15a and the second pivot 15b is selected to support the swing point 12a of the upper arm 12, thus making it possible to adjust the roll center height position to a desired position.

Thus, according to the adjustment adapter 15B of the present modification example, either of the two position settings of the swing point 12a of the upper arm 12 can be selectively made by using a single member. This enables a setting of a predetermined roll center height position in accordance with vehicle specifications even for vehicle types having different vehicle specifications.

The disclosure is not limited to the embodiment, but various modifications and applications can be naturally made without departing from the spirit of the disclosure. Furthermore, the embodiment includes disclosures at various stages, and the various disclosures can be extracted from the embodiment by appropriately combining disclosed elements. For example, even if some elements are removed from all the elements indicated in the one embodiment, this configuration in which the elements are removed can be extracted as the disclosure as long as the problem to be solved by the disclosure can be solved and the advantageous effects of the disclosure can be obtained. Furthermore, constituent elements in different embodiments may be appropriately combined. This disclosure is not restricted by the specific aspects except for the limitation by the accompanying claims.

In vehicles such as automobiles, shortening of a development period and reduction of a manufacturing cost are constantly desired. For this reason, for example, design using a common platform is widely implemented in different vehicle types (vehicles having different vehicle specifications such as a vehicle height (suspension orientation or wheel outer diameter) and a tread) and the like.

In this case, for example, even if the vehicle specifications are different, setting a roll center height position as a suspension parameter to be substantially the same can maintain the maneuverability, the ride comfort performance, and the like at substantially the same level. Hence, setting the roll center height position in a substantially similar manner between different vehicle types leads to more efficient development of the vehicle.

Here, a roll center refers to an instantaneous center, which is a fulcrum when left and right suspension apparatuses of the vehicle start to move and a vehicle body rolls. For example, for a double wishbone suspension apparatus, the roll center can be indicated as the intersection where line segments coupling intersections of extension lines of lower arms and extension lines of upper arms and road surface contact points of the wheels intersect.

The roll center will be described more briefly with reference to FIG. 4. FIG. 4 is a diagram for describing the roll center and schematically illustrating left and right wheels of a vehicle and suspension apparatuses (double wishbone) provided for the left and right wheels. In FIG. 4, it is assumed that the vehicle is viewed from front of or behind the vehicle toward the front or the rear of the vehicle.

In FIG. 4, reference sign 12 denotes each of left and right upper arms of the left and right suspension apparatuses. The left and right upper arms 12 each have one end 12a and the other end 12b. Here, the one end 12a is a fixing part that is fixed on a vehicle body side and swingably supports the upper arm 12. The other end 12b is fixed to a knuckle (not illustrated) on a wheel 20 side and serves as an action point following swinging of the knuckle.

In FIG. 4, reference sign 11 denotes each of left and right lower arms of the left and right suspension apparatuses. The left and right lower arms 11 each have one end 11a and the other end 11b. Here, the one end 11a is a fixing part that is fixed on the vehicle body side and swingably supports the lower arm 11. The other end 11b is fixed to a knuckle (not illustrated) on the wheel 20 side and serves as an action point following swinging of the knuckle.

In this case, reference sign S denotes an extension line of a line coupling the one end 12a and the other end 12b of each of the left and right upper arms 12. Reference sign T denotes an extension line of a line coupling the one end 11a and the other end 11b of each of the left and right lower arms 11. Each of intersections of the extension lines S and the extension lines T is referred to as an instantaneous rotation center M when a wheel 20 is about to move up and down.

When reference sign C denotes (two) straight lines coupling the instantaneous rotation centers M and contact center points TC of the wheels 20, an intersection RC of the two straight lines C is referred to as the roll center.

On the other hand, when a common platform is used, for example, the same suspension apparatus is sometimes applied to vehicles having different vehicle specifications and the like. When such a structure is adopted, if left unchanged, the setting of the roll center height position varies depending on vehicle specifications and the like.

Thus, when the same suspension apparatus is used between vehicles having different vehicle specifications and the like, a measure is taken to set the roll center height position to be the same. As a measure in this case, for example, in the suspension apparatus, the following is conceivable:
(1) setting to lower the inner side (vehicle body mounting side) of the lower arm; or
(2) setting to raise the inner side (vehicle body mounting side) of the upper arm.

In this case, for example, as for the approach of (1) above, the minimum ground height becomes lower. Additionally, as for the approach of (2) above, a problem is that a specification of a vehicle (specification of a different vehicle body mounting position of the upper arm) is involved for each of the vehicle specifications, and many types of vehicles are involved.

For example, Japanese Unexamined Patent Application Publication (JP-A) No. 2019-1328 proposes a suspension apparatus including a roll center variable mechanism capable of adjusting a roll center height during traveling of a vehicle.

The roll center variable mechanism in the suspension apparatus described in JP-A No. 2019-1328 and the like is configured such that an arm mounting part that moves up and down with respect to a main body of the roll center variable mechanism is mounted to an upper arm. The arm mounting part is moved up and down by a drive mechanism including a motor and the like. The driving of the drive mechanism is controlled by a suspension control apparatus.

However, the suspension apparatus described in JP-A No. 2019-1328 and the like is intended to obtain traveling stability by adjusting a roll center height of a traveling vehicle. For this reason, there is a problem that the apparatus configuration becomes highly complicated and the apparatus becomes larger and more expensive.

It is desirable to provide a roll center height position adjustment mechanism capable of setting a roll center height position at substantially the same position even for vehicles having different vehicle specifications at the stage of basic design of the vehicle.

Obviously, numerous: modifications and variations of the present invention are possible in light of the above teachings. It is therefore to be understood that within the scope of the appended claims, the invention may be practiced otherwise than as specifically described herein.

1. A roll center height position adjustment mechanism for adjusting a roll center height position in a suspension apparatus for a vehicle, comprising:
a lower arm swingably supporting a wheel in an up-down direction with respect to a vehicle body of a vehicle;
an upper arm swingably supporting the wheel in the up-down direction with respect to the vehicle body; and
an intermediate mounting member positioned between the upper arm and the vehicle body and fixing the upper arm to the vehicle body,
wherein the lower arm is positioned such that the lower arm has an upward inclination from a position lower than a rotation center of the wheel toward the vehicle body, the upper arm is positioned such that the upper arm has a downward inclination from a position higher than the rotation center of the wheel toward the vehicle body, and the intermediate mounting member has a vehicle body mounting portion such that the vehicle body mounting portion is a point at which the upper arm is fixed to the vehicle body and has a roll center height position configured to be set variably in accordance with vehicle specifications.

2. The roll center height position adjustment mechanism according to claim 1, wherein the vehicle specifications include at least one of a vehicle height and a tread that is a center-to-center distance of left and right wheels in a vehicle width direction.

3. The roll center height position adjustment mechanism according to claim 2, wherein the intermediate mounting member is provided in a plurality in accordance with types of the vehicle specifications such that one of the plurality of intermediate mounting members is appropriately and selectively mounted to the vehicle.

4. The roll center height position adjustment mechanism according to claim 2, wherein the vehicle body mounting portion is provided in a plurality in accordance with types of the vehicle specifications such that the upper arm is appropriately and selectively fixed at one of the plurality of vehicle body mounting portions.
